(19) United States
(12) Patent Application Publication
(10) Pub. No.: US 2014/0016348 A1
(43) Pub. Date: Jan. 16, 2014

(54) PLANAR LIGHTING DEVICE

(71) Applicant: FUJIFILM CORPORATION, Tokyo (JP)

(72) Inventor: Osamu IWASAKI, Kanagawa (JP)

(73) Assignee: FUJIFILM CORPORATION, Tokyo (JP)

(21) Appl. No.: 14/034,432

(22) Filed: Sep. 23, 2013

Related U.S. Application Data
(63) Continuation of application No. PCT/JP2012/051327, filed on Jan. 23, 2012.

(30) Foreign Application Priority Data
Mar. 28, 2011 (JP) 2011-069859

(51) Int. Cl. F21V 8/00

(52) U.S. Cl. CPC G02B 6/0041; G02B 6/0051
USPC 362/606

(57) ABSTRACT

The invention provides a planar lighting device in which a large size and a small thickness in which front luminance of outgoing light is high and in which moire fringes due to a pattern formed in a light guide plate and a micro-lens film can be suppressed to emit outgoing light with small luminance unevenness, thereby enhancing light use efficiency. The object is attained by providing the planar lighting device with a light guide sheet that has scattering particles dispersed in the light guide sheet, and that is not more than 2 mm thick in a direction perpendicular to the light exit surface, an optical member unit including a micro-lens film with a plurality of spherical micro-ball lenses formed on a film that is so disposed as to face the light exit surface.

### BACKGROUND OF THE INVENTION

The present invention relates to a planar lighting device used in a liquid crystal display or the like.

A liquid crystal display uses a planar lighting device (a backlight unit) which illuminates a liquid crystal display panel by irradiation with light from the back side of the liquid crystal display panel. The backlight unit is configured using a light guide plate for diffusing light emitted from an illumination light source to illuminate the liquid crystal display panel and parts such as a prism sheet and a diffusion sheet for making outgoing light from the light guide plate uniform.

Currently, large-size liquid crystal televisions predominantly use a so-called direct backlight unit including a light guide plate disposed immediately above an illumination light source. This type of backlight unit ensures uniform light intensity distribution and necessary luminance by disposing a plurality of cold cathode tubes used as light sources behind the liquid crystal display panel and providing the inside of the backlight unit with white reflection surfaces.

However, the direct backlight unit requires a thickness of about 30 mm in a direction perpendicular to the liquid crystal display panel in order to make the light intensity distribution uniform, and accordingly, further reduction in thickness is difficult to achieve.

On the other hand, an exemplary backlight unit that allows the thickness reduction includes one using a light guide plate which guides light, which is emitted from an illumination light source and caused to enter from a surface, in predetermined directions, and emits the guided light through a light exit surface that is different from the surface through which the light is caused to enter.

As a backlight unit using such a light guide plate, a backlight unit of a type using a plate-like light guide member in which a pattern for emitting outgoing light is formed on the front surface or the surface opposite to the front surface (back surface) of the light guide plate by printing, laser beam patterning, ink jet printing, or the like and which causes light to enter from the side surface thereof and causes light to exit through the front surface thereof has been proposed.

In the backlight unit using the plate-like light guide member which causes light to enter from the side surface thereof and causes light to exit through the front surface thereof, since the light incident direction is different by 90° from the light exit direction, front luminance of outgoing light is lower than that in the direct backlight unit in which the light incident direction and the light exit direction are the same. Accordingly, by disposing a micro-lens film on the front surface of the light guide plate to concentrate outgoing light in a direction perpendicular to the front surface, the front luminance of outgoing light of the backlight unit is improved.

For example, JP 09-113730 A discloses a surface light source device in which a pattern for deflecting light inside a light conducting plate gradually toward a direction perpendicular to the light emitting surface of the light conducting plate and a pattern for causing light emitted from the light conducting plate to be converged in the direction of a plane perpendicular to both the light incident side surface and the light emitting surface are each formed either at the light emitting surface or the surface opposite thereto of the light conducting plate, or at both surfaces.

JP 2001-033783 A discloses a liquid crystal display in which a backlight unit disposed on the rear surface side of a liquid crystal display element has a light guide plate and in which the light guide plate includes scattering means for scattering light and directive reflecting means for selectively emitting light in a predetermined direction.

JP 2006-114239 A discloses a light guiding member for a planar light source comprising a light guide plate in which prism-like reflective grooves for reflecting light entering from a side surface thereof and propagating therein to the front surface are disposed on the rear surface side and/or in the inside thereof, and a sheet in which micro-lenses or cylindrical lenses corresponding to the individual reflective grooves are arranged and which is disposed on the front surface side of the light guide plate.

### SUMMARY OF THE INVENTION

As described above, with an increase in size of a liquid crystal display, an increase in size and a decrease in thickness and weight are required for a backlight unit. Accordingly, as described above, various backlight units using a light guide plate in which a light source is disposed on a side surface of the light guide plate and the light guide plate guides light entering from the side surface in a predetermined direction and emits the light through a light exit surface (front surface) have been proposed. In this way, by disposing a light source on the side surface of the light guide plate, it is possible to realize a decrease in thickness and weight, compared with a backlight unit in which a light source is disposed on the rear surface of a light guide plate. However, an additional decrease in thickness is required for a large-size display such as a large-size liquid crystal television. For the purpose of an additional decrease in thickness of a backlight unit, it is necessary to further decrease the thickness of a light guide plate into a sheet shape.

However, in such a backlight unit as disclosed in JP 09-113730 A, JP 2001-033783 A or JP 2006-114239 A, that is, in a backlight unit of a type using a plate-like light guide member in which a pattern for emitting outgoing light is formed on the light exit surface or the rear surface of the light guide plate and which causes light to enter from the side surface thereof and causes light to exit through the front surface thereof, when the thickness of the light guide plate decreases for the purpose of the additional decrease in thickness of the backlight unit and a micro-lens film is disposed on the front surface of the light guide plate in order to improve front luminance of outgoing light, moire fringes occur on the light exit surface or the rear surface of the light guide plate due to an interference of a structure of a pattern formed by printing, laser beam patterning, ink jet printing, or the like with a structure of the micro-lens film. As a countermeasure against the moire fringes, it can be considered that a backlight unit is disposed apart from a liquid crystal panel, that the number of diffusing films disposed on the front surface of the light guide plate is increased, or the like. However, in these cases, since the moire fringes are reduced by shading off outgoing light, the luminance of outgoing light is lowered and thus light use efficiency is lowered. In addition, by separating the backlight unit and the liquid crystal panel from each other or increasing the number of diffusing films, the thickness of the apparatus as a whole increases.

An object of the present invention is to solve the above-mentioned problems of the related art and to provide a backlight unit with a large size and a small thickness in which front luminance of outgoing light is high and in which moire fringes due to a pattern formed in a light guide plate and a micro-lens film can be suppressed to emit outgoing light with small luminance unevenness, thereby enhancing light use efficiency.

In order to attain the above-described object, the present invention provides a planar lighting device comprising: a light guide sheet that has a rectangular light exit surface, one or more light incidence surfaces, the one light incidence surface being disposed on a side of an edge of the light exit surface and allowing light traveling in a direction parallel to the light exit surface to enter into the light guide sheet, a rear surface opposite with the light exit surface, and scattering particles dispersed in the light guide sheet and that is not more than 2 mm thick in a direction perpendicular to the light exit surface; one or more light source units, the one light source unit being so disposed as to face the light incidence surface of the light guide sheet; and an optical member unit including a micro-lens film with a plurality of spherical micro-ball lenses formed on a film that is so disposed as to face the light exit surface.

Preferably, the light guide sheet includes two or more layers stacked in the direction perpendicular to the light exit surface and having the scattering particles dispersed therein at different particle concentrations.

Preferably, the two or more layers of the light guide sheet respectively vary in thickness in the direction perpendicular to the light exit surface so that a combined particle concentration of the light guide sheet may have a first local maximum value on a side of the one light incidence surface and a second local maximum value larger and more distant from the one light incidence surface than the first local maximum value in a direction perpendicular to the one light incidence surface.

Preferably, the light guide sheet includes a first layer on a side of the light exit surface and a second layer on a side of the rear surface, with the second layer having the scattering particles dispersed therein at a higher particle concentration than in the first layer, and wherein the second layer continuously varies in thickness so that the thickness may increase, then decrease before increase again as a distance from the one light incidence surface is increased in the direction perpendicular to the one light incidence surface.

Preferably, the light guide sheet has two light incidence surfaces disposed on sides of two edges of the light exit surface opposed to each other, and wherein the second layer continuously varies in thickness so that the thickness may increase, then decrease before increase again as distances from the two light incidence surfaces are increased in a direction perpendicular to the two light incidence surfaces, and be maximum in a middle of the light exit surface.

Or, preferably, the light guide sheet has a single light incidence surface disposed on a side of one edge of the light exit surface, and wherein the second layer continuously varies in thickness so that the thickness may increase, then decrease before increase again as a distance from the single light incidence surface is increased in a direction perpendicular to the single light incidence surface, and be maximum on a side of a surface opposite with the light incidence surface.

Preferably, when the particle concentration of the first layer of the light guide sheet is represented by Npo and the particle concentration of the second layer is represented by Npr, the Npo and the Npr fall in ranges of Npo=0 wt % and 0.01 wt %<Npr<0.8 wt %, respectively.

Or, preferably, when the particle concentration of the first layer of the light guide sheet is represented by Npo and the particle concentration of the second layer is represented by Npr, the Npo and the Npr satisfy relations expressed as 0 wt %<Npo<0.15 wt % and Npo<Npr<0.8 wt %.

Preferably, the rear surface of the light guide sheet is a flat surface parallel to the light exit surface.

Preferably, the micro-ball lenses of the micro-lens film have a diameter ranging from 10 μm to 100 μm.

Preferably, when a diameter of the micro-ball lenses of the micro-lens film is represented by D_{L} and a height of the micro-ball lenses is represented by H_{L}, the diameter D_{L} and the height H_{L} satisfy a relation expressed as D_{L}/2≧H_{L}≧D_{L}/8.

Preferably, the micro-ball lenses of the micro-lens film are randomly arranged on the film.

Preferably, the micro-ball lenses of the micro-lens film have surfaces with a root-mean-square gradient ranging from 0.1 to 7.5.

Preferably, the light guide sheet has a length of not less than 300 mm in a direction perpendicular to the one light incidence surface.

The backlight unit according to the present invention comprises the light guide sheet having a thickness of 2 mm or less in the direction perpendicular to the light exit surface and having scattering particles dispersed therein and the optical member including a micro-lens film which is disposed to face the light exit surface of the light guide sheet and in which plural semispherical micro-ball lenses are formed on a film. In the inventive backlight unit as such, even with a large size and a small thickness, the front luminance of outgoing light emitted therefrom is high and moire fringes due to a pattern formed in the light guide plate and a micro-lens film can be suppressed to emit outgoing light with small luminance unevenness, thereby enhancing light use efficiency.

### BRIEF DESCRIPTION OF THE DRAWINGS

FIG. 1 is a schematic perspective view showing an embodiment of a liquid crystal display provided with a planar lighting device according to the present invention.

FIG. 2 is a cross-sectional view of the liquid crystal display shown in FIG. 1 taken along line II-II.

FIG. 3A shows a cross section of the planar lighting device in FIG. 2 taken along line III-III and viewed in the direction of arrows, and FIG. 3B is a cross-sectional view taken along line B-B of FIG. 3A.

FIG. 4A is a perspective view showing the schematic configuration of a light source unit of the planar lighting device shown in FIGS. 1 and 2, and FIG. 4B is an enlarged schematic perspective view showing one of LEDs forming the light source unit shown in FIG. 4A.

FIG. 5 is a schematic perspective view showing the shape of a light guide sheet shown in FIG. 3A.

FIGS. 6A to 6E are schematic cross-sectional views illustrating other examples of the light guide sheet used in the planar lighting device according to the present invention.

FIG. 7 is a schematic cross-sectional view illustrating another example of the light guide sheet used in the planar lighting device according to the present invention.

FIG. 8A is a partially-enlarged diagram schematically illustrating a micro-lens film shown in FIG. 2, and FIG. 8B is a cross-sectional view taken along line C-C of FIG. 8A.

FIG. 9 is a schematic cross-sectional view illustrating another example of the planar lighting device according to the present invention.

FIG. 10 is a schematic cross-sectional view illustrating another example of the planar lighting device according to the present invention.

FIG. 11 is a graph illustrating a measurement result of a luminance distribution of light emitted from a light exit surface of a planar lighting device.

FIGS. 12A and 12B are graphs each illustrating an angular distribution of intensity of light emitted from a light exit surface of a planar lighting device.

### DETAILED DESCRIPTION OF THE INVENTION

A planar lighting device according to the invention will be described below in detail with reference to preferred embodiments shown in the accompanying drawings.

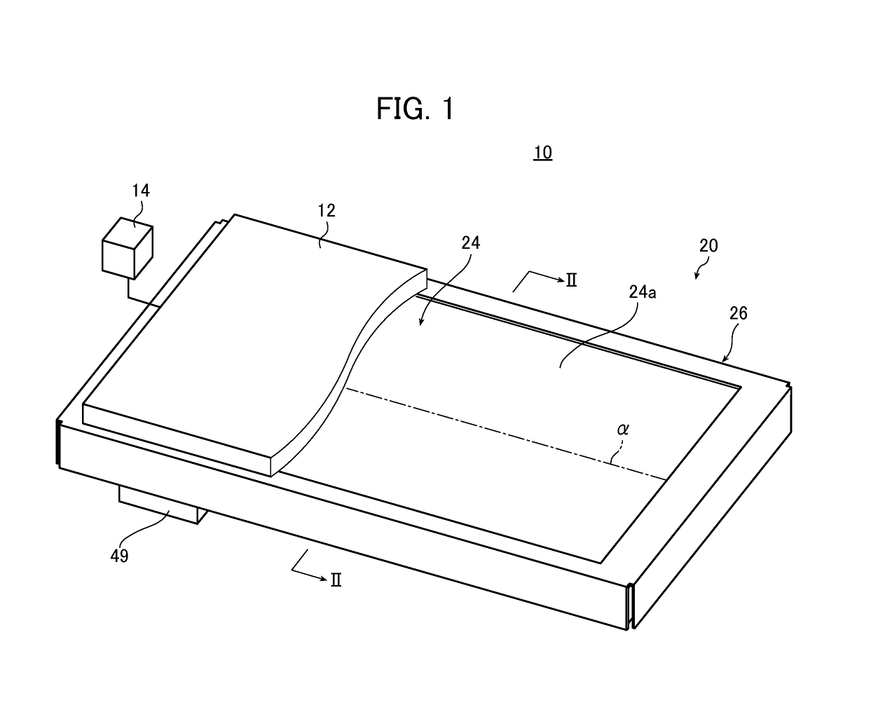

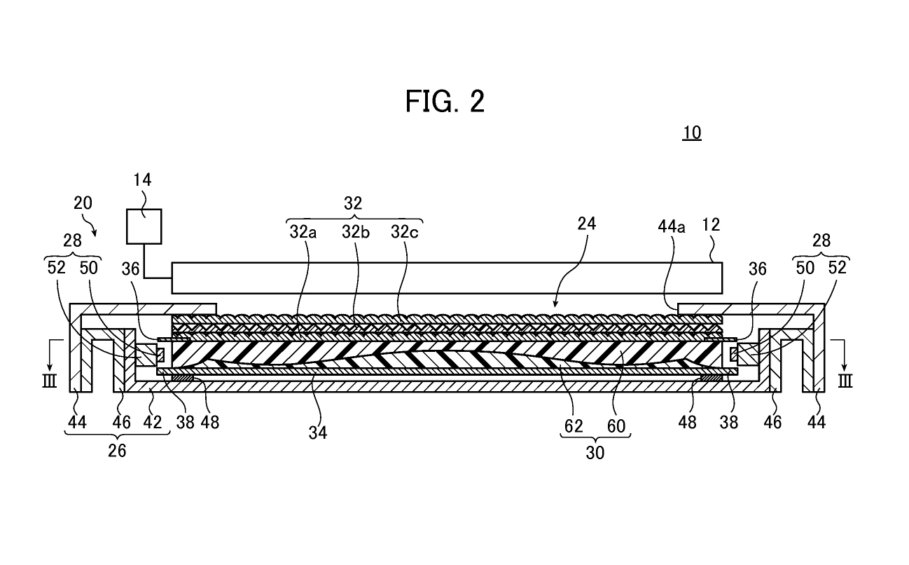

FIG. 1 is a perspective view schematically showing a liquid crystal display provided with the planar lighting device according to the invention and FIG. 2 is a cross-sectional view of the liquid crystal display of FIG. 1 taken along line II-II.

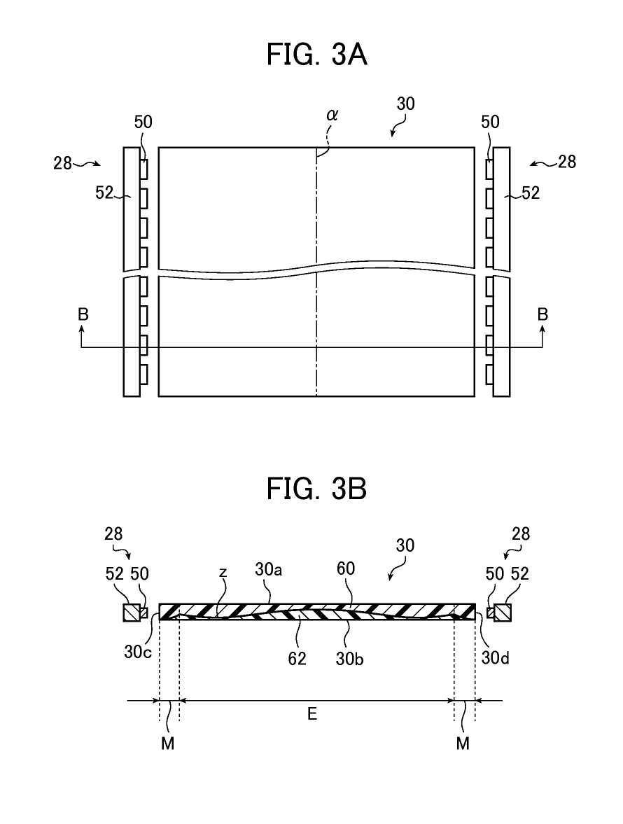

FIG. 3A shows a cross section of the planar lighting device (also referred to below as “backlight unit”) in FIG. 2 taken along line III-III and viewed in the direction of arrows, and FIG. 3B is a cross-sectional view taken along line B-B of FIG. 3A.

A liquid crystal display 10 comprises a backlight unit 20, a liquid crystal display panel 12 disposed on the side closer to the light exit surface of the backlight unit 20, and a drive unit 14 for driving the liquid crystal display panel 12. In FIG. 1, parts of the liquid crystal display panel 12 are not shown to illustrate the configuration of the backlight unit.

In the liquid crystal display panel 12, an electric field is partially applied to liquid crystal molecules previously arranged in a specified direction to thereby change the orientation of the molecules. As a result, changes in refractive index occur in the liquid crystal cells, and the changes in refractive index are used to display characters, figures, images and the like on the surface of the liquid crystal display panel 12.

The drive unit 14 applies a voltage across transparent electrodes in the liquid crystal display panel 12 to change the orientation of the liquid crystal molecules, thereby controlling the transmittance of light passing through the liquid crystal display panel 12.

The backlight unit 20 is a lighting device for illuminating the whole surface of the liquid crystal display panel 12 from the back side of the liquid crystal display panel 12 and comprises a light exit surface 24a of which the shape is substantially the same as an image display surface of the liquid crystal display panel 12.

As shown in FIGS. 1, 2, 3A, and 3B, the backlight unit 20 according to this embodiment comprises a lighting device main body 24 having two light source units 28, a light guide sheet 30, and an optical member unit 32 and a housing 26 having a lower housing 42, an upper housing 44, a folded member 46, and a support member 48. As shown in FIG. 1, a power unit casing 49 containing a plurality of power supplies for supplying the light source units 28 with electric power is disposed on the back side of the lower housing 42 of the housing 26.

Components constituting the backlight unit 20 will be described below.

The lighting device main body 24 comprises the light source units 28 for emitting light, the light guide sheet 30 for emitting the light incident from the light source units 28 as planar light, and the optical member unit 32 for scattering and concentrating the light emitted from the light guide sheet 30 to provide more uniform light with a higher front luminance.

First, the light source units 28 will be described.

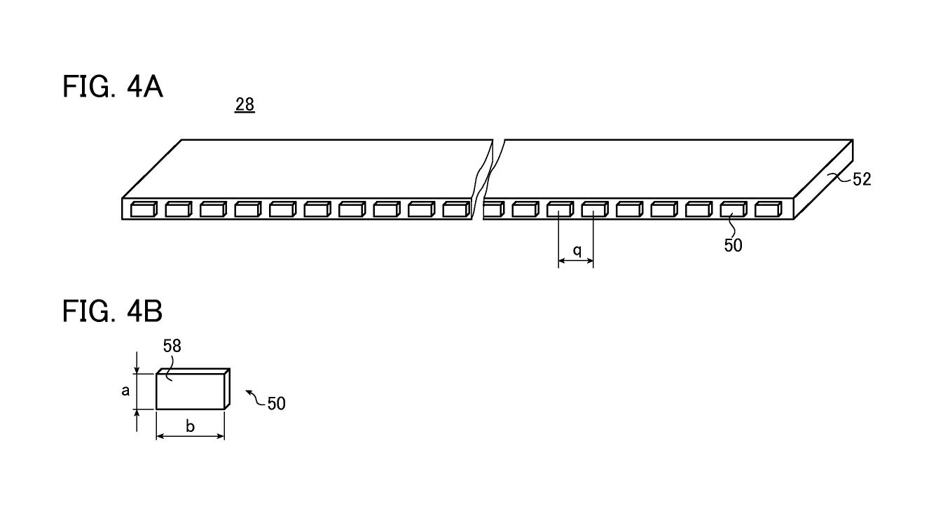

FIG. 4A is a schematic perspective view schematically showing the configuration of the light source unit 28 of the backlight unit 20 shown in FIGS. 1 and 2. FIG. 4B is an enlarged schematic perspective view showing only one LED chip of the light source unit 28 shown in FIG. 4A.

As shown in FIG. 4A, the light source unit 28 comprises a plurality of light emitting diode chips (referred to below as “LED chips”) 50 and a light source support 52.

The LED chip 50 is a chip of a light emitting diode emitting blue light, which has a phosphor applied to the surface thereof. The LED chip 50 has a light-emitting face 58 with a predetermined area and emits white light from the light-emitting face 58.

Specifically, when blue light emitted from the surface of the light emitting diode of the LED chip 50 passes through the phosphor, the phosphor generates fluorescence. Thus, the blue light emitted from the light emitting diode is combined with the fluorescence from the phosphor to produce white light, which is emitted from the LED chip 50.

Examples of the LED chip 50 include a chip obtained by applying a yttrium aluminum garnet (YAG) phosphor to the surface of a GaN light emitting diode, an InGaN light emitting diode or the like.

The light source support 52 is a plate-like member of which one surface faces the light incidence surface (30c or 30d) of the light guide sheet 30.

The light source support 52 supports plural LED chips 50 on a side surface facing the light incidence surface (30c or 30d) of the light guide sheet 30 with the LED chips spaced from each other by a predetermined interval. Specifically, the plural LED chips 50 constituting the light source unit 28 are arranged in an array shape in the length direction of a first light incidence surface 30c or a second light incidence surface 30d of the light guide sheet 30 to be described later, that is to say, arranged parallel to the edge at which the light exit surface 30a and the first light incidence surface 30c meet or the edge at which the light exit surface 30a and the second light incidence surface 30d meet, and are fixed to the light source support 52.

The light source support 52 is formed of a metal having high heat conductivity such as copper or aluminum and also serves as a heat sink absorbing heat generated from the LED chips 50 and dissipating the generated heat to the outside. The light source support 52 may be provided with fins capable of increasing the surface area and the heat dissipation effect or heat pipes for transferring heat to a heat dissipating member.

As shown in FIG. 4B, each LED chip 50 according to this embodiment has a rectangular shape in which the length in a direction perpendicular to the arrangement direction of the LED chips 50 is smaller than the length in the arrangement direction, that is, a rectangular shape in which the thickness direction (direction perpendicular to the light exit surface 30a) of the light guide sheet 30 to be described later is a short side. In other words, the LED chip 50 has a shape which satisfies b>a where the length in the direction perpendicular to the light exit surface 30a of the light guide sheet 30 is defined as a and the length in the arrangement direction is defined as b. When the arrangement interval of the LED chips 50 is defined as q, q>b is satisfied. In this way, it is preferable that the relationship of the length a in the direction perpendicular to the light exit surface 30a of the light guide sheet 30, the length b in the arrangement direction, and the arrangement interval q of the LED chips 50 satisfy q>b>a.

By setting each LED chip 50 to a rectangular shape, it is possible to provide a thin light source while maintaining an output with large light intensity. By decreasing the thickness of the light source unit 28, it is possible to decrease the thickness of a backlight unit. It is also possible to reduce the number of LED chips arranged.

While the LED chips 50 each preferably have a rectangular shape with the short side lying in the thickness direction of the light guide plate 30 for a thinner design of the light source unit 28, the invention is not limited thereto and LED chips having various shapes such as a square shape, a circular shape, a polygonal shape, and an elliptical shape may be used.

Next, the light guide sheet 30 will be described below.

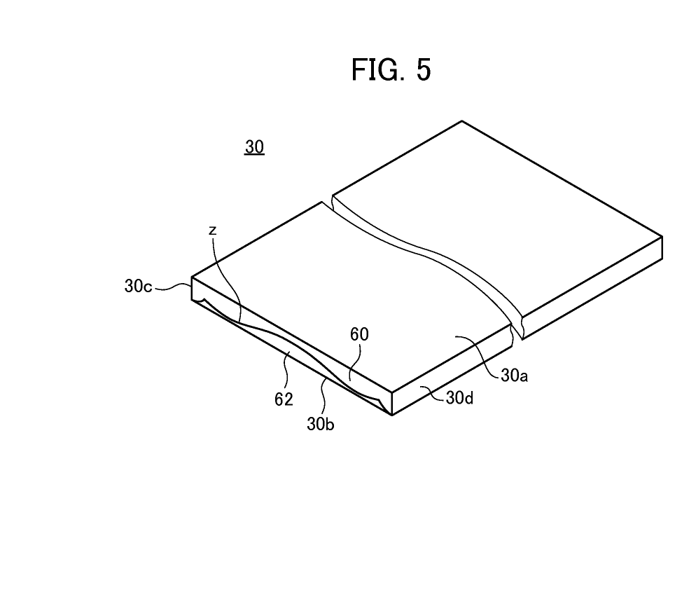

FIG. 5 is a schematic perspective view showing the shape of the light guide sheet 30.

The light guide sheet 30 is a sheet-like light guide member having a thickness of 2 mm or less. As shown in FIGS. 2, 3A, 3B, and 5, the light guide sheet 30 includes the rectangular light exit surface 30a, the two light incidence surfaces (the first light incidence surface 30c and the second light incidence surface 30d) formed at both ends on the long side of the light exit surface 30a so as to be substantially perpendicular to the light exit surface 30a, and a flat rear surface 30b located on the opposite side of the light exit surface 30a, that is, on the back side of the light guide sheet 30.

In the following description, when the first light incidence surface 30c and the second light incidence surface 30d do not have to be distinguished from each other, they are simply referred to as light incidence surfaces.

The two light sources 28 mentioned above are disposed so as to face the first light incidence surface 30c and the second light incidence surface 30d of the light guide sheet 30, respectively. In this embodiment, the light-emitting face 58 of each LED chip 50 in the light source units 28 has substantially the same length as the first light incidence surface 30c and the second light incidence surface 30d in the direction substantially perpendicular to the light exit surface 30a.

Thus, the backlight unit 20 has the two light source units 28 disposed so as to interpose the light guide sheet 30 therebetween. In other words, the light guide sheet 30 is disposed between the two light source units 28 facing each other with a predetermined space therebetween.

The light guide sheet 30 is formed by mixing and dispersing scattering particles for scattering light into a transparent resin. Exemplary materials of the transparent resin used for the light guide sheet 30 include optically transparent resins such as PET (polyethylene terephthalate), PP (polypropylene), PC (polycarbonate), PMMA (polymethyl methacrylate), benzyl methacrylate, MS resin, and COP (cycloolefin polymer). Silicone particles such as TOSPEARL (registered trademark), silica particles, zirconia particles, dielectric polymer particles, and the like may be used as the scattering particles to be mixed and dispersed into the light guide sheet 30.

The light guide sheet 30 has a two-layer structure including a first layer 60 on the side closer to the light exit surface 30a and a second layer 62 on the side closer to the rear surface 30b. When the boundary between the first layer 60 and the second layer 62 is referred to as “interface z”, the first layer 60 has a sectional region surrounded by the light exit surface 30a, the first light incidence surface 30c, the second light incidence surface 30d, and the interface z. On the other hand, the second layer 62 is a layer adjacent to the first layer 60 on the side closer to the rear surface 30b and has a sectional region surrounded by the interface z and the rear surface 30b.

Here, the light guide sheet 30 is partitioned into the first layer 60 and the second layer 62 by the interface z, but the first layer 60 and the second layer 62 are different from each other only in particle concentration, have a configuration in which the same scattering particles are dispersed in the same transparent resin, and are structurally integrated. That is, when the light guide sheet 30 is partitioned with the interface z as a reference, the particle concentrations of the regions are different from each other, but the interface z is only a virtual surface and the first layer 60 and the second layer 62 are integrated.

When the particle concentration of the scattering particles in the first layer 60 and the particle concentration of the scattering particles in the second layer 62 are denoted by Npo and Npr, respectively, Npo and Npr have a relationship expressed by Npo<Npr. That is, in the light guide sheet 30, the second layer on the side closer to the rear surface 30b contains the scattering particles at a higher particle concentration than the first layer on the side closer to the light exit surface 30a.

When seen from a cross-section perpendicular to the longitudinal direction of the light incidence surface, the interface z between the first layer 60 and the second layer 62 continuously varies so that the second layer 62 is the largest in thickness at the position corresponding to the bisector a (that is, the central portion of the light exit surface 30a) and decreases in thickness from the position corresponding to the bisector α toward the first light incidence surface 30c and the second light incidence surface 30d, and then continuously varies so that the second layer once increases in thickness in the vicinity of the first light incidence surface 30c and the second light incidence surface 30d and then decreases in thickness again.

Specifically, the interface z includes a curved surface convex toward the light exit surface 30a in the central portion of the light guide sheet 30, concave curved surfaces smoothly connected to the convex curved surface, and concave curved surfaces connected to the concave curved surfaces and connected to ends of the light incidence surfaces 30c and 30d on the side closer to the rear surface 30b. The thickness of the second layer 62 on the light incidence surfaces 30c and 30d is zero.

In this way, the thickness of the second layer 62 containing scattering particles at a higher particle concentration than that in the first layer 60 continuously varies so that the second layer has a first local maximum value in thickness in the vicinities of the light incidence surfaces and a second local maximum value at the central portion of the light guide sheet having the largest thickness, and accordingly, the combined particle concentration of the scattering particles varies so as to have the first local maximum value in the vicinity of each of the first and second light incidence surfaces (30c and 30d) and the second local maximum value at the central portion of the light guide sheet, the second local maximum value being larger than the first local maximum value.

Here, the combined particle concentration in the invention means a concentration of scattering particles expressed using the amount of scattering particles added (combined) in a direction substantially perpendicular to the light exit surface at a position spaced apart from one light incidence surface toward the other on the assumption that the light guide sheet is a flat plate having the thickness at the light incidence surfaces throughout the light guide sheet. In other words, the combined particle concentration means the number of scattering particles per unit volume or a weight percentage with respect to the base material of scattering particles added in a direction substantially perpendicular to the light exit surface at a position spaced apart from the light incidence surface on the assumption that the light guide sheet is a flat light guide sheet which has the thickness of the light incidence surfaces throughout the light guide sheet and which has the same concentration.

As a method of forming such a light guide sheet 30, a method of forming a base film containing scattering particles as a first layer using an extrusion method or the like, forming a second layer having a desired particle concentration by applying a monomer resin liquid (liquid of a transparent resin) in which scattering particles are dispersed onto the base film and irradiating ultraviolet rays or visual rays to the applied monomer resin liquid to cure the monomer resin liquid and form a film-like light guide sheet can be used. A two-layer extrusion method or the like can also be used.

The first local maximum value in thickness of the second layer 62 (combined particle concentration) is located at the edge of an opening 44a of the upper housing 44 (see FIG. 2). The regions from the light incidence surfaces 30c and 30d to their corresponding positions of the first local maximum value are located outside the opening 44a of the upper housing 44, that is, in the frame portion forming the opening 44a, and thus do not contribute to the emission of light as the backlight unit 20. In other words, the regions from the light incidence surfaces 30c and 30d to their corresponding positions of the first local maximum value are so-called mixing zones M for diffusing light having entered through the light incidence surfaces. The region which is closer to the central portion of the light guide sheet than the mixing zones M, that is, the region corresponding to the opening 44a of the upper housing 44, is an effective screen area E and is a region contributing to the emission of light as the backlight unit 20.

In this way, the light guide sheet 30 having a thickness of 2 mm or less in the direction perpendicular to the light exit surface and having scattering particles dispersed therein does not have a structure on the surface thereof and thus, can scatter incident light and emit the incident light as outgoing light from the light exit surface. Accordingly, even when a micro-lens film is disposed as an optical member unit 32 disposed on the side of the light exit surface 30a of the light guide sheet 30 so as to improve front luminance of outgoing light, it is possible to prevent occurrence of moire fringes.

This point will be described in detail later.

In this way, by adjusting the combined particle concentration of the light guide sheet 30 (thickness of the second layer) so as to have the second local maximum value which is the largest in the central portion of the light guide sheet, light entering through the light incidence surfaces 30c and 30d can travel to positions farther from the light incidence surfaces 30c and 30d even if the light guide sheet is a large and thin light guide sheet of which the thickness is 2 mm or less, whereby outgoing light has a luminance distribution which is high in the middle.

In addition, by adjusting the combined particle concentration so as to have the first local maximum value in the vicinities of the light incidence surfaces 30c and 30d, light entering through the light incidence surfaces 30c and 30d can be sufficiently diffused in the vicinities of the light incidence surfaces to prevent a bright line (dark line, unevenness) due to arrangement intervals of light sources (LEDs) or the like from being visualized in the outgoing light emitted from the vicinity of the light incidence surface.

Moreover, by adjusting the combined particle concentration so that the regions on the sides closer to the light incidence surfaces 30c and 30d than the positions where the combined particle concentration takes the first local maximum value have a lower combined particle concentration than the first local maximum value, return light, which is light emitted through the light incidence surfaces after it once enters the light guide sheet, and outgoing light emitted through the regions in the vicinities of the light incidence surfaces (mixing zones M) which are not used because the regions are covered with the housing can be reduced, thereby improving use efficiency of light emitted through an effective region of the light exit surface (effective screen area E).

Moreover, by locating the position at which the combined particle concentration has the first local maximum value to be closer to the light incidence surfaces 30c and 30d than the opening 44a of the upper housing 44, it is possible to reduce outgoing light emitted through the regions in the vicinities of the light incidence surfaces (mixing zones M) which are not used because the regions are covered with the housing, thereby improving use efficiency of light emitted from the effective region (effective screen area E) of the light exit surface.

The adjustment of the shape of the interface z enables the luminance distribution (the concentration distribution of scattering particles) as well to be set as desired to improve the efficiency to the maximum extent possible.

In addition, since the particle concentration of the layer on the side closer to the light exit surface is reduced, the total amount of scattering particles used can be reduced, thereby leading to cost reduction.

In the illustrated example, the combined particle concentration is adjusted so as to have the first local maximum value at the edge of the opening 44a of the upper housing 44, but the invention is not limited to this configuration. The combined particle concentration may have the first local maximum value at positions inside the opening 44a or in the frame portion of the surface of the upper housing 44 having the opening 44a (outside the opening 44a), as long as the combined particle concentration has the first local maximum value near the edge of the opening 44a of the upper housing 44. In other words, the combined particle concentration may have the first local maximum value at positions in the effective screen area E or at positions in the mixing zones M.

In the light guide sheet 30 shown in FIG. 2, light emitted from the light source units 28 and allowed to enter the light guide sheet 30 through the first light incidence surface 30c and the second light incidence surface 30d is scattered by a scattering material (scattering particles) contained in the light guide sheet 30, as it travels through the inside of the light guide sheet 30, and is emitted through the light exit surface 30a directly or after having been reflected by the rear surface 30b. At this time, part of light may leak through the rear surface 30b but the leaked light is reflected by a reflecting plate 34 disposed on the side closer to the rear surface 30b of the light guide sheet 30 and enters the light guide sheet 30 again. The reflecting plate 34 will be described later in detail.

Further, the particle concentration Npo of the scattering particles in the first layer 60 and the particle concentration Npr of the scattering particles in the second layer 62 preferably satisfy the relationships of 0 wt %<Npo<0.15 wt % and Npo<Npr<0.8 wt %.

When the first layer 60 and the second layer 62 of the light guide sheet 30 satisfy the above relationships, the light guide sheet 30 can guide incident light to the inside (center) of the light guide sheet 30 without scattering the incident light so much in the first layer 60 having a lower particle concentration, and the light is scattered by the second layer 62 having a higher particle concentration as it approaches the center of the light guide sheet, thereby increasing the amount of light emitted through the light exit surface 30a. In brief, the illuminance distribution which is high in the middle at a preferable ratio can be obtained while further enhancing the light use efficiency.

The particle concentration [wt %] mentioned herein means a ratio of the weight of the scattering particles to the weight of the base material.

Alternatively, the particle concentration Npo of the scattering particles in the first layer 60 and the particle concentration Npr of the scattering particles in the second layer 62 preferably satisfy the relationships of Npo=0 wt % and 0.01 wt %<Npr<0.8 wt %. In other words, the light guide sheet 30 may be configured such that the scattering particles are not mixed and dispersed in the first layer 60 so as to guide incident light to a deep part of the light guide sheet 30 and the scattering particles are mixed and dispersed only in the second layer 62 so as to further scatter the light as it approaches the center of the light guide sheet, thereby increasing the amount of light emitted through the light exit surface 30a.

Since the first layer 60 and the second layer 62 of the light guide sheet 30 satisfy the above-mentioned relationships, the illuminance distribution which is high in the middle at a preferable ratio can be obtained while further enhancing the light use efficiency.

When the backlight unit is increased in size, the particle concentration of scattering particles which are dispersed in the light guide sheet needs to be lowered to guide light to a deep part of the light guide sheet. However, when the particle concentration is lowered, front luminance tends to be lowered. On the contrary, by combining the light guide sheet having scattering particles dispersed therein with the micro-lens film, it is possible to suppress occurrence of moire fringes and to improve front luminance of outgoing light, even when the backlight unit 20 has a size corresponding to a liquid crystal display of 40 inches or more and the distance from the first light incidence surface 30c to the second light incidence surface 30d of the light guide sheet 30 is set to be equal to or more than 300 mm.

In the light guide sheet 30 of the example shown in the drawing, the interface z has a shape which is a curved surface concave to the light exit surface 30a in regions from the positions of the first local maximum value to the light incidence surfaces 30c and 30d and which is connected to end portions of the light incidence surfaces 30c and 30d on the side of the rear surface 30b, but the present invention is not limited to this shape.

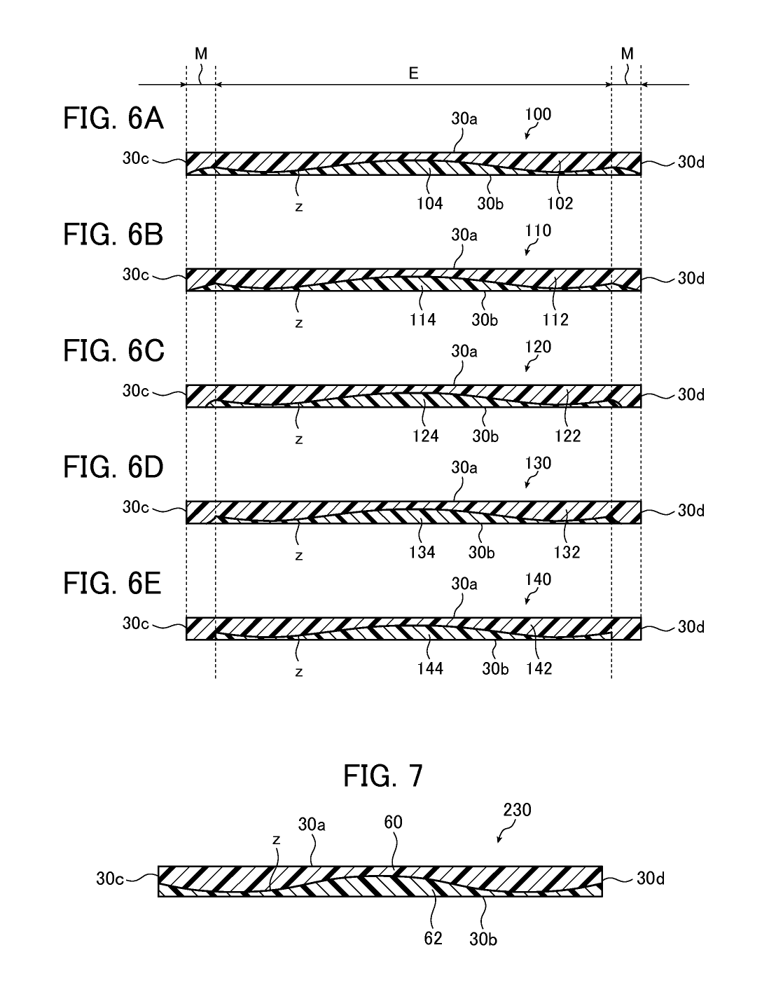

FIGS. 6A to 6E are schematic diagrams illustrating other examples of the light guide sheet used in the backlight unit according to the present invention.

Light guide sheets 100, 110, 120, 130, and 140 shown in FIGS. 6A to 6E have the same configuration as the light guide sheet 30 shown in FIG. 3B, except that the thicknesses of the first layer and the second layer in the mixing zones M, that is, the shape of the interface z from the light incidence surfaces 30c and 30d to the positions of the first local maximum value is changed. Accordingly, the same elements will be referenced by the same reference numerals and different elements will be mainly described below.

The light guide sheet 100 shown in FIG. 6A is composed of a first layer 102 and a second layer 104 having a particle concentration higher than that of the first layer 102. The shape of the interface z between the first layer 102 and the second layer 104 in each mixing zone M is a curved surface which is convex to the light exit surface 30a and which is connected to the position of the first local maximum value and the end portion of the light incidence surface 30c or 30d on the side of the rear surface 30b.

The light guide sheet 110 shown in FIG. 6B is composed of a first layer 112 and a second layer 114 having a particle concentration higher than that of the first layer 112. The shape of the interface z between the first layer 112 and the second layer 114 in each mixing zone M is a flat surface which is connected to the position of the first local maximum value and the end portion of the light incidence surface 30c or 30d on the side of the rear surface 30b.

The light guide sheet 120 shown in FIG. 6C is composed of a first layer 122 and a second layer 124 having a particle concentration higher than that of the first layer 122. The shape of the interface z between the first layer 122 and the second layer 124 in each mixing zone M is a curved surface which is convex to the light exit surface 30a and which is connected to the position of the first local maximum value and the rear surface 30b substantially at the center of the relevant mixing zone M.

The light guide sheet 130 shown in FIG. 6D is composed of a first layer 132 and a second layer 134 having a particle concentration higher than that of the first layer 132. The shape of the interface z between the first layer 132 and the second layer 134 in each mixing zone M is a curved surface which is concave to the light exit surface 30a and which is connected to the position of the first local maximum value and the rear surface 30b substantially at the center of the relevant mixing zone M.

The light guide sheet 140 shown in FIG. 6E is composed of a first layer 142 and a second layer 144 having a particle concentration higher than that of the first layer 142. In each mixing zone M, the light guide sheet 140 has only the first layer 142. That is, the shape of the interface z is a flat surface which is located at the position of the first local maximum value and is parallel to the light incidence surface 30c or 30d.

As in the light guide sheets shown in FIGS. 6A to 6E, by forming the shape of the interface z so as to reduce the thickness of the second layer from the positions of the first local maximum value to the light incidence surfaces 30c and 30d, the combined particle concentration of the regions from the positions of the first local maximum value to the light incidence surfaces 30c and 30d (mixing zones M) is set to a combined particle concentration lower than the first local maximum value and it is thus possible to reduce return light which is incident light emitted from the light incidence surfaces or outgoing light emitted from the regions in the vicinities of the light incidence surfaces (mixing zones M) which are not used because the regions are covered with the housing, thereby improving use efficiency of light emitted from an effective region (effective screen area E) of the light exit surface.

In a cross-section perpendicular to the longitudinal direction of the light incidence surface, the concave curved surfaces and the convex curved surfaces forming the interface z may be curves expressed as parts of a circle or an ellipse, quadratic curves, curves expressed by polynomials, or combined curves thereof.

In the example shown in the drawing, by continuously varying the thickness of the second layer so as to have a first local maximum value which once becomes large in the vicinity of the light incidence surface and a second local maximum value which is the largest at the center of the light guide sheet, the combined particle concentration of scattering particles has a first local maximum value in the vicinity of the first and second light incidence surfaces (30c and 30d) and a second local maximum value larger than the first local maximum value at the center of the light guide sheet, but the present invention is not limited to this configuration. For example, a configuration in which the thickness of the second layer having a high particle concentration is the largest at the center of the light guide sheet and decreases as it goes to the first and second light incidence surfaces, that is, a configuration in which the interface between the first layer and the second layer is convex to the light exit surface, may be employed.

By setting the interface to be convex to the light exit surface and causing the combined particle concentration to increase from the light incidence surfaces to the center of the light guide sheet, it is possible to send light entering from the light incidence surfaces to a more distant position and thus to set the luminance distribution of outgoing light to a luminance distribution which is high in the middle.

Alternatively, similarly to a light guide sheet 230 shown in FIG. 7, a configuration in which the thickness of the second layer having a high particle concentration continuously varies so as to be the largest at the center of the light guide sheet, then to decrease as it goes from the center to the light incidence surfaces 30c and 30d, and then to increase again in the vicinity of the light incidence surfaces 30c and 30d may be employed.

In this way, by employing the configuration in which the thickness of the second layer having a high particle concentration continuously varies so as to be the largest at the center of the light guide sheet, then to decrease as it goes from the center to the light incidence surfaces, and then to increase again in the vicinity of the light incidence surfaces 30c and 30d and causing the combined particle concentration to continuously vary from the vicinity of the light incidence surfaces toward the center of the light guide sheet so as to once decrease and then to increase and to vary so as to be the highest at the center of the light guide sheet, it is possible to send light entering from the light incidence surfaces to a more distant position and thus to set the luminance distribution of outgoing light to a luminance distribution which is high in the middle. In addition, since light entering from the light incidence surface can be sufficiently diffused in the vicinity of the light incidence surface, it is possible to prevent a bright line (dark line, unevenness) due to arrangement intervals of the light sources (LEDs) or the like from being visualized in outgoing light emitted from the vicinity of the light incidence surface.

In the example shown in the drawing, the light guide sheet comprises two layers having different particle concentrations of scattering particles, but the present invention is not limited to this configuration. For example, a light guide sheet comprising a single layer having a uniform particle concentration or a light guide sheet comprising three or more layers having different particle concentrations may be employed. When a light guide sheet having three or more layers is used, it is preferable that the thicknesses of the layers are varied in the direction perpendicular to the light incidence surface so that the combined particle concentration of the scattering particles has a first local maximum value in the vicinity of the first and second light incidence surfaces (30c and 30d) and a second local maximum value larger than the first local maximum value at the center of the light guide sheet.

In the illustrated example, the light exit surface 30a is a flat surface, but the invention is not limited thereto. The light exit surface may be a concave surface. By employing the concave surface as the light exit surface, it is possible to prevent the light guide sheet from warping toward the light exit surface upon expansion or contraction of the light guide sheet due to heat or moisture, thus from coming contact with the liquid crystal display 12.

In the examples shown in the drawings, the rear surface 30b is a flat surface, but is not limited to the flat surface, and the rear surface may be a concave surface, that is, a surface inclined in a direction in which the thickness decreases as it goes away from the light incidence surfaces or may be a convex surface, that is a surface inclined in a direction in which the thickness increases as it goes away from the light incidence surfaces.

The optical member unit 32 will be described below.

The optical member unit 32 serves to make the illumination light as emitted from the light exit surface 30a of the light guide sheet 30 be light having less luminance unevenness and less illuminance unevenness, to concentrate the illumination light in the direction perpendicular to the light exit surface 30a, and to emit the illumination light from the light exit surface 24a of the lighting device main body 24. As shown in FIG. 2, the optical member unit 32 includes a micro-lens film 32a disposed to face the light exit surface 30a of the light guide sheet 30, a prism sheet 32b disposed to face the surface of the micro-lens film 32a from which light is emitted, the prism sheet 32b having an array of micro-prisms formed parallel to the edges at which the light incidence surfaces 30c and 30d and the light exit surface 30a meet, and a micro-lens film 32c disposed to face the surface of the prism sheet 32b from which light is emitted.

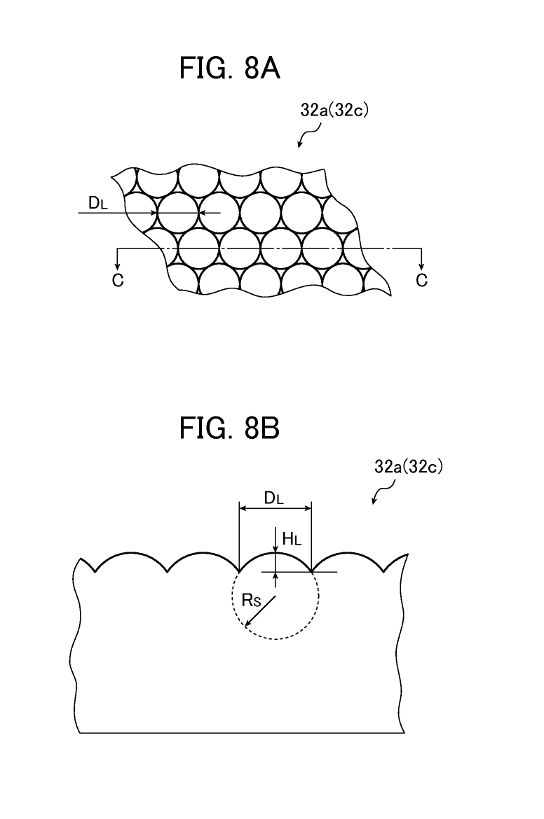

FIG. 8A is a partially-enlarged diagram schematically illustrating the micro-lens film 32a (32c) when seen from the direction perpendicular to the light exit surface and FIG. 8B is a cross-sectional view taken along line C-C of FIG. 8A.

As shown in FIGS. 8A and 8B, the micro-lens film 32a and the micro-lens film 32c are formed by arranging plural spherical micro-ball lenses on a transparent film in a closest packing manner and concentrate incident light in a direction perpendicular to the film.

Each micro-ball lens in the example shown in the drawings is a micro lens with a spherical diameter of R_{S}, a lens diameter of D_{L}, and a height of F_{L}.

As described above, in a backlight unit employing a light guide plate which causes light to enter from a side surface of the light guide plate (light guide sheet) and causes light to exit from the front surface thereof, since the light incidence direction and the light exit direction are different from each other by 90°, the front luminance (luminance in the direction perpendicular to the light exit surface) of outgoing light is lower than that in the direct backlight unit in which the light incidence direction and the light exit direction are the same. Accordingly, by disposing the micro-lens film on the side of the light exit surface of the light guide plate and concentrating outgoing light in the direction perpendicular to the light exit surface, the front luminance of outgoing light of the backlight unit is improved.

However, when a light guide plate, in which a pattern for emitting outgoing light is formed on the light exit surface or the rear surface of the light guide plate by printing, laser beam patterning or the like, is combined with a micro-lens film, as described in JP 09-113730 A, JP 2001-033783 A or JP 2006-114239 A, moire fringes are likely to occur due to interference of a structure of the pattern formed on the light exit surface or the rear surface of the light guide plate with a structure of the micro-lens film. Particularly, since the moire fringes easily occur as the thickness of the light guide plate decreases, it is difficult to decrease the thickness of the light guide plate. Moreover, since it is necessary to suppress the moire fringes by disposing the backlight unit to be apart from a liquid crystal panel or increasing the number of diffusing films disposed on the surface of the light guide plate, it is difficult to decrease the thickness of the backlight unit or the liquid crystal display as a whole. With an increase in the number of diffusing films or an increase in the thickness of the housing, cost increases.

In addition, in the case where the backlight unit is disposed to be apart from the liquid crystal panel or the number of diffusing films disposed on the surface of the light guide plate are increased to suppress occurrence of the moire fringes, the luminance of outgoing light is lowered, thereby lowering light use efficiency.

On the contrary, the backlight unit according to the present invention comprises the light guide sheet having a thickness of 2 mm or less in the direction perpendicular to the light exit surface and having scattering particles dispersed therein and the optical member including the micro-lens film which is disposed to face the light exit surface of the light guide sheet and in which plural spherical micro-ball lenses are formed on a film. Accordingly, even when the thickness of the light guide plate is decreased and the micro-lens film is provided to enhance the front luminance of outgoing light, a structure for scattering light is not disposed on the surface of the light guide sheet and it is thus possible to suppress occurrence of moire fringes due to the structure and to emit outgoing light with less luminance unevenness.

In addition, since it is not necessary to dispose the backlight unit and the liquid crystal display panel to be apart from each other or to dispose plural diffusing films so as to shade off the moire fringes, it is possible to decrease the thickness of the device as a whole and to enhance light use efficiency.

Here, the diameter D_{L} of the micro-ball lenses formed in the micro-lens films 32a and 32c preferably ranges from 10 μm to 100 μm. It is considered that an interference effect can be neglected, when the diameter D_{L} of the micro-ball lenses is about 10 times the wavelength in a visible range. Accordingly, the diameter of the micro-ball lenses is preferably set to 10 μm or more, a value 10 times or more the maximum wavelength of 780 nm in the visible range. On the other hand, since the micro-ball lenses are likely to be visually recognized when the diameter thereof is large, the diameter of the micro-ball lenses is preferably set to 100 μm or less.

Therefore, by setting the diameter D_{L} of the micro-ball lenses within the range of 10 μm to 100 μm, it is possible to suitably concentrate illumination light emitted from the light exit surface 30a of the light guide sheet 30 and entering the film and thus to improve the front luminance and the light use efficiency.

The height H_{L} and the diameter D_{L} of the micro-ball lenses preferably satisfy a relationship of D_{L}/2≧H_{L}≧D_{L}/8. When the height H_{L} and the diameter D_{L} satisfy the relationship of H_{L}>D_{L}/2, the micro-lens film has considerable surface irregularities and the mechanical strength thereof may be insufficient. When height H_{L} and the diameter D_{L} satisfy the relationship of H_{L}<D_{L}/8, interference may occur at a wavelength in the visible range.

Therefore, when the height H_{L} and the diameter D_{L} of the micro-ball lenses satisfy the relationship of D_{L}/2≧H_{L}≧D_{L}/8, it is possible to suitably concentrate illumination light emitted from the light exit surface 30a of the light guide sheet 30 and entering the film and thus to improve the front luminance and the light use efficiency.

The arrangement density of the micro-ball lenses is not particularly limited and can be determined depending on performance required for the device or the like. By adjusting the arrangement density of the micro-ball lenses, it is possible to adjust the front luminance of illumination light emitted from the backlight unit 20. For example, when it is intended to increase the front luminance of the illumination light emitted from the backlight unit 20, it is possible to increase the light intensity concentrated in the direction perpendicular to the light incidence surfaces by forming the micro-ball lenses in a closest-packed pattern, thereby increasing the front luminance.

It is preferable that the micro-ball lenses be randomly arranged. By randomly arranging the micro-ball lenses, it is possible to reduce occurrence of moire or the like due to the structure of the micro-lens films 32a and 32c.

Further, regarding the surface roughness of the micro-ball lenses, the root-mean-square gradient ZΔq is preferably set to 0.1≦ZΔq≦7.5. By setting the surface roughness of the micro-ball lenses within this range to give them a diffusing property, light emitted from the light exit surface 30a and entering the film can be concentrated in the direction perpendicular to the light exit surface 30a and it is thus possible to further improve the front luminance of illumination light emitted from the backlight unit 20 and the light use efficiency. By setting the surface roughness of the micro-ball lenses within this range to give them a diffusing property, it is possible to further improve the front luminance and thus to reduce the number of various optical sheets used in the optical member unit, thereby reducing the cost thereof.

The height H_{C} of the irregularities as surface roughness of the micro-ball lenses is preferably set to 0.78 μm≦H_{C}≦H_{L}/10. In order to scatter light, the height H_{C} of the irregularities is preferably larger than 0.78 μm, the maximum wavelength of the visible light. In consideration of the mechanical strength of the micro-lens film 32a (32c), the height H_{C} of the irregularities is preferably set to be equal to or less than 1/10 of the height H_{L} of the micro-ball lenses.

The prism sheet 32b is not particularly limited and known prism sheets can be used. For example, the prism sheet described in paragraphs [0028] to [0033] of JP 2005-234397 A which is an application of the applicant of the present invention can be used.

In this embodiment, the optical member unit 32 is composed of two micro-lens films 32a and 32c and the prism sheet 32b disposed between the two micro-lens films, but the arrangement order and the numbers of the micro-lens films and the prism sheets are not particularly limited. The optical member unit may be composed of a single micro-lens film and a single prism sheet.

The optical member unit 32 is composed of the prism sheet in addition to the micro-lens films, but the optical member unit 32 is not limited to this configuration and various optical members may be employed. For example, a diffusing sheet or a transmittance adjusting member in which many transmittance adjusters formed of diffusing reflectors are arranged depending on luminance unevenness and illuminance unevenness may be used as an optical member in addition to or instead of the prism sheet.

Next, the reflecting plate 34 of the lighting device main body 24 will be described below.

The reflecting plate 34 is disposed to reflect light leaking from the rear surface 30b of the light guide sheet 30 and to cause the reflected light to enter the light guide sheet 30 again and can improve light use efficiency. The reflecting plate 34 is formed in a shape corresponding to the rear surface 30b of the light guide sheet 30 so as to cover the rear surface 30b. In this embodiment, as shown in FIG. 2, since the rear surface 30b of the light guide sheet 30 is a flat surface, that is, the cross-section thereof is formed in a linear shape, the reflecting plate 34 is also formed in a shape corresponding thereto.

The reflecting plate 34 may be formed of any material as long as it can reflect light leaking from the rear surface 30b of the light guide sheet 30. For example, the reflecting plate can be formed of a resin sheet in which voids are formed to enhance reflectance by mixing a filler in PET, PP (Polypropylene), or the like and then stretching the resultant, a sheet in which a specular surface is formed on the surface of a transparent or white resin sheet through aluminum evaporation or the like, foil of metal such as aluminum or a resin sheet carrying metal foil, or a thin metal sheet having a sufficient reflection property on the surface thereof.

Two upper light guide reflecting plates 36 are disposed between the light guide sheet 30 and the micro-lens film 32a, that is, on the light exit surface 30a side of the light guide sheet 30 so as to cover the light source units 28 and the end portions of the light exit surface 30a of the light guide sheet 30 (an end portion on the side of the first light incidence surface 30c and an end portion on the side of the second light incidence surface 30d), respectively. In other words, the upper light guide reflecting plates 36 are each disposed so as to cover from a part of the light exit surface 30a of the light guide sheet 30 to a part of the light source support 52 of the light source unit 28 in the direction parallel to the optical axis direction. That is, the two upper light guide reflecting plates 36 are disposed at both ends of the light guide sheet 30.

By arranging the upper light guide reflecting plates 36 in this way, it is possible to prevent light emitted from the light source units 28 from leaking onto the side of the light exit surface 30a without entering into the light guide plate 30.

Accordingly, it is possible to cause light emitted from the light source units 28 to efficiently enter the first light incidence surface 30c and the second light incidence surface 30d of the light guide plate 30, thereby improving light use efficiency.

Lower light guide reflecting plates 38 are disposed on the rear surface 30b side of the light guide sheet 30 so as to partially cover the light source units 28. An end of each lower light guide reflecting plate 38 closer to the center of the light guide sheet 30 is connected to the reflecting plate 34.

Here, the upper light guide reflecting plates 36 and the lower light guide reflecting plates 38 can be formed of any of various materials available for the reflecting plate 34.

By providing the lower light guide reflecting plates 38, it is possible to prevent light emitted from the light source units 28 from leaking onto the side of the rear surface 30b of the light guide sheet 30 without entering into the light guide sheet 30.

Accordingly, it is possible to cause light emitted from the light source units 28 to efficiently enter the first light incidence surface 30c and the second light incidence surface 30d of the light guide sheet 30, thereby improving light use efficiency.

In this embodiment, the reflecting plate 34 is connected to the lower light guide reflecting plates 38, but the present invention is not limited to this configuration and the reflecting plate and the lower light guide reflecting plates may be formed as different members.

The shapes and the widths of the upper light guide reflecting plates 36 and the lower light guide reflecting plates 38 are not particularly limited, as long as they can reflect light emitted from the light source units 28 toward the first light incidence surface 30c or the second light incidence surface 30d, cause the light emitted from the light source units 28 to enter the first light incidence surface 30c or the second light incidence surface 30d, and can guide the light entering the light guide sheet 30 toward the center of the light guide sheet 30.

In this embodiment, the upper light guide reflecting plates 36 are disposed between the light guide sheet 30 and the micro-lens film 32a, but the arrangement positions of the upper light guide reflecting plates 36 are not limited to this. The upper light guide reflecting plates may be disposed between sheet-like members constituting the optical member unit 32 or may be disposed between the optical member unit 32 and the upper housing 44.

Next, the housing 26 will be described below.

As shown in FIG. 2, the housing 26 receives and supports the lighting device main body 24 and holds and secures the lighting device main body 24 from the side closer to the light exit surface 24a and the side closer to the rear surface 30b of the light guide sheet 30. The housing 26 has the lower housing 42, the upper housing 44, the folded member 46, and the support member 48.

The lower housing 42 is open at the top and has a shape formed by a bottom section and lateral sections provided upright on four sides of the bottom section. In brief, the lower housing 42 has a substantially rectangular box shape of which one face is open. As shown in FIG. 2, the lower housing 42 supports the lighting device main body 24 received therein from above on the bottom section and the lateral sections and covers the surfaces of the lighting device main body 24 other than the light exit surface 24a, that is, the opposite surface of the lighting device main body 24 to the light exit surface 24a (rear surface) and the lateral surfaces thereof.

The upper housing 44 has the shape of a rectangular box which has at the top a rectangular opening 44a smaller than the rectangular light exit surface 24a of the lighting device main body 24 and which is open at the bottom.

As shown in FIG. 2, the upper housing 44 is disposed to cover the lighting device main body 24 and the lower housing 42 receiving the main body, including the four lateral sections of the housing 42, from above the lighting device main body 24 and the lower housing 42 (from the light exit surface side).

The folded member 46 has a cross-sectional shape which is a fixed concave (U) shape. That is, the folded member is a rod-like member of which the shape of the cross-section perpendicular to the extending direction is a U-shape.

Of the two folded members 46 as shown in FIG. 2, each is inserted between the side surface of the lower housing 42 and the side surface of the upper housing 44, and the outer surface of one parallel portion of the U shape is joined to the side surface of the lower housing 42 and the outer surface of the other parallel portion is joined to the side surface of the upper housing 44.

Here, as the method of joining the folded member 46 to the lower housing 42 and the method of joining the folded member 46 to the upper housing 44, various known methods such as a method using bolts and nuts and a method using an adhesive can be used.

By disposing the folded members 46 between the lower housing 42 and the upper housing 44 in this way, it is possible to enhance the rigidity of the housing 26 and thus to prevent the light guide sheet 30 from being bent. Accordingly, for example, when a light guide sheet capable of efficiently emitting light with no luminance unevenness and no illuminance unevenness or with small luminance unevenness and small illuminance unevenness but liable to warp is used, it is possible to satisfactorily correct the warp or to satisfactorily prevent the light guide sheet form warping, thereby emitting light with no luminance unevenness and no illuminance unevenness or with reduced luminance unevenness and reduced illuminance unevenness from the light exit surface.

Various materials such as metal and resin can be used for the upper housing, the lower housing, and the folded member of the housing. A material having small weight and high strength can be preferably used as the material.

In this embodiment, the folded member is formed as an independent member, but may be formed as a unified body with the upper housing or the lower housing. The folded member may not be provided.

The support member 48 is a rod-like member of which the shape of the cross-section perpendicular to the extending direction is fixed.

The two support members 48 as shown in FIG. 2 are disposed between the lower housing 42 and the reflecting plate 34, more specifically between the lower housing 42 and the reflecting plate 34 at the positions corresponding to the end portion on the side of the first light incidence surface 30c and the end portion on the side of the second light incidence surface 30d of the rear surface 30b of the light guide sheet 30. The support members 48 fix the light guide sheet 30 and the reflecting plate 34 to the lower housing 42, and support them.

By supporting the reflecting plate 34 using the support members 48, it is possible to bring the light guide sheet 30 and the reflecting plate 34 into close contact with each other. It is also possible to fix the light guide sheet 30 and the reflecting plate 34 to a predetermined position in the lower housing 42.

In this embodiment, the support members are provided as independent members, but the support member is not limited to this configuration and may be formed as a unified body with the lower housing 42 or the reflecting plate 34. That is, protruding portions may be formed in a part of the lower housing 42 and the formed protruding portions may be used as the support members, or protruding portions may be formed in a part of the reflecting plate 34 and the formed protruding portions may be used as the support members.

The arrangement positions thereof are not particularly limited, and the support members can be disposed at any position between the reflecting plate and the lower housing. However, in order to stably hold the light guide sheet, the support members are preferably disposed on the sides of the ends of the light guide sheet, that is, in the vicinity of the first light incidence surface 30c and in the vicinity of the second light incidence surface 30d in this embodiment.

The shape of the support member 48 is not particularly limited, and the support member may have various shapes and may be formed of various materials. For example, plural support members may be arranged at predetermined intervals.

The support member may have a shape filling the entire space formed by the reflecting plate and the lower housing. That is, the surface on the side of the reflecting plate may have a shape corresponding to the reflecting plate and the surface on the side of the lower housing may have a shape corresponding to the lower housing. When the entire surface of the reflecting plate is supported by the use of the support member in this way, it is possible to satisfactorily prevent the light guide sheet and the reflecting plate from being separated from each other and thus to prevent occurrence of luminance unevenness and illuminance unevenness by light reflected by the reflecting plate.

The function of the backlight unit 20 configured as described above will be described.

In the backlight unit 20, light emitted from the light source units 28 disposed at both ends of the light guide sheet 30 enters the light incidence surfaces (the first light incidence surface 30c and the second light incidence surface 30d) of the light guide sheet 30. The light entering from the respective surfaces is scattered by the scattering material contained in the light guide sheet 30 as the light travels inside the light guide sheet 30 and is emitted from the light exit surface 30a directly or after being reflected by the rear surface 30b. At this time, a part of the light leaking from the rear surface is reflected by the reflecting plate 34 and enters the light guide sheet 30 again.

In this way, the light emitted from the light exit surface 30a of the light guide sheet 30 passes through the optical member unit 32 and is emitted from the light exit surface 24a of the lighting device main body 24, thereby illuminating the liquid crystal display panel 12.

The liquid crystal display panel 12 uses the drive unit 14 to control the light transmittance according to the position so as to display characters, figures, images and the like on the surface of the liquid crystal display panel 12.

In the above-mentioned embodiment, double-side incidence in which two light source units are disposed on two light incidence surfaces of the light guide sheet has been used, but the present invention is not limited to this configuration, and single-side incidence in which only one light source unit is disposed on a single light incidence surface of the light guide sheet may be used. By reducing the number of light source units, it is possible to reduce the number of components and thus to reduce cost.

In case of the single-side incidence, a light guide sheet in which the shape of the interface z is asymmetric may be used. For example, a light guide sheet which has one light incidence surface and of which the shape of the second layer is asymmetric such that the thickness of the second layer of the light guide sheet is the maximum at a position more distant from the light incidence surface than the bisector of the light exit surface may be used.

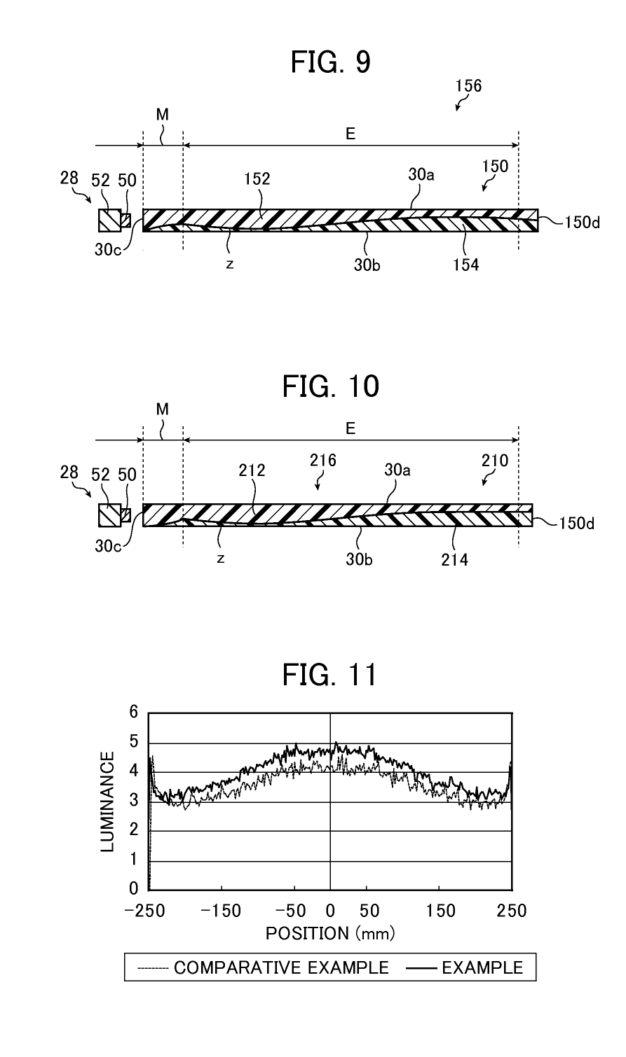

FIG. 9 is a schematic cross-sectional view illustrating another example of the backlight unit according to the present invention. The backlight unit 156 shown in FIG. 9 has the same configuration as the backlight unit 20, except that a light guide sheet 150 is used instead of the light guide sheet 30 and only one light source unit 28 is used. Accordingly, the same elements will be referenced by the same reference numerals and the differences will be mainly described below.

The backlight unit 156 shown in FIG. 9 comprises a light guide sheet 150 and a light source unit 28 disposed to face a first light incidence surface 30c of the light guide sheet 150.

The light guide sheet 150 has a first light incidence surface 30c which is a surface disposed to face the light source unit 28 and a side surface 150d which is the opposite surface of the first light incidence surface 30c.

The light guide sheet 150 is formed of a first layer 152 on the side of a light exit surface 30a and a second layer 154 on the side of a rear surface 30b. The interface z between the first layer 152 and the second layer 154 continuously varies so that the thickness of the second layer 154 initially increases from the first light incidence surface 30c toward the side surface 150d, and the thickness of the second layer 154 temporarily decreases, then the thickness of the second layer 154 increases again and decreases on the side of the side surface 150d, when seen in a cross-section perpendicular to the length direction of the first light incidence surface 30c.

Specifically, the interface z includes a curved surface convex to the light exit surface 30a on the side of the side surface 150d, a concave curved surface smoothly connected to the convex curved surface, and a convex curved surface connected to the concave curved surface and connected to the end of the light incidence surface 30c on the side of the rear surface 30b. The thickness of the second layer 154 is 0 on the light incidence surface 30c.

That is, the combined particle concentration of scattering particles (the thickness of the second layer) varies so as to have a first local maximum value in the vicinity of the first light incidence surface 30c and a second local maximum value larger than the first local maximum value at a position closer to the side surface 150d than the center of the light guide sheet.

Although not shown in the drawing, the position of the first local maximum value of the combined particle concentration of the light guide sheet 150 is located at the boundary of the opening of the housing, and the region from the light incidence surface 30c to the position of the first local maximum value is a so-called mixing zone M for diffusing light entering from the light incidence surface.

In this way, in case of the single-side incidence using only one light source unit, the combined particle concentration (the thickness of the second layer 154) of the light guide sheet 150 is set to a concentration having the first local maximum value at a position close to the light incidence surface 30c and the second local maximum value larger than the first local maximum value at a position closer to the side surface 150d than the central portion. Accordingly, even in a large-size and thin light guide sheet, light entering from the light incidence surface can be sent to a position further distant from the light incidence surface, which allows the luminance distribution of outgoing light to be high in the middle.

In addition, by disposing the position of the first local maximum value of the combined particle concentration in the vicinity of the light incidence surface, it is possible to satisfactorily diffuse light entering from the light incidence surface in the vicinity of the light incidence surface and thus to prevent a bright line (dark line, unevenness) due to the arrangement interval of the light sources (LEDs) or the like from being visualized in outgoing light emitted from the vicinity of the light incidence surface.

Moreover, by setting the region closer to the light incidence surface than the position of the first local maximum value of the combined particle concentration to a combined particle concentration lower than the first local maximum value, it is possible to reduce return light as incident light to be emitted from the light incidence surface or outgoing light from the region (mixing zone M) in the vicinity of the light incidence surface which is not used because the region is covered with the housing and thus to improve use efficiency of light emitted from the effective region (effective screen area E) of the light exit surface.

In the light guide sheet 150 of the backlight unit 156 shown in FIG. 9, the shape of the interface z in the mixing zone M is set to a curved surface convex to the light exit surface 30a which is connected to the end of the light incidence surface 30c on the side of the rear surface 30b. However, the shape of the interface z is not limited to this, and it may be a curved surface concave to the light exit surface or may be a flat surface.

The shape of the interface z in the effective screen area E of the light guide sheet 150 shown in FIG. 9 is set to a shape in which the thickness of the second layer 154 decreases from the position of the first local maximum value toward the side surface 150d, then increases to the second local maximum value, and decreases again, but the shape of the interface z is not limited to this shape.

FIG. 10 is a schematic diagram illustrating another example of the backlight unit according to the present invention.

A backlight unit 216 shown in FIG. 10 has the same configuration as the backlight unit 156 shown in FIG. 9, except that the thicknesses of the first layer 152 and the second layer 154 in the effective screen area E of the light guide sheet 150, that is, the shape of the interface z from the position of the first local maximum value to the vicinity of the side surface 150d is changed. Accordingly, the same elements will be referenced by the same reference numerals and the differences will be mainly described below.

A light guide sheet 210 of the backlight unit 216 shown in FIG. 10 is composed of a first layer 212 and a second layer 214 having a particle concentration higher than that of the first layer 212. The interface z between the first layer 212 and the second layer 214 in the effective screen area E has a shape in which the thickness of the layer 214 decreases from the position of the first local maximum value toward the side surface 150d, then increases to the second local maximum value, and is constant to the side surface 150d.

In this way, by making the shape of the interface z asymmetric by means of a combination of a curved surface and a flat surface so that in the effective screen area E, the combined particle concentration of scattering particles is the minimum at a position closer to the light incidence surface and is the maximum at a position distant from the light incidence surface, it is possible to guide light emitted from the light source and entering from the light incidence surface to a deep part of the light guide sheet, thereby obtaining an appropriate luminance distribution and improving light use efficiency.

The backlight unit according to the present invention is not limited to this configuration either, and in addition to two light source units, a light source unit may be disposed to face a side surface on the short side of the light exit surface of the light guide sheet. By increasing the number of light source units, it is possible to enhance the intensity of light emitted from the device.

Light may be emitted from the rear surface as well as the light exit surface.

### Example

The present invention will be described in more detail below with reference to a specific example of the present invention.

In the Example, the intensity of outgoing light emitted from a light exit surface was calculated through computer simulation using a backlight unit shown in FIG. 2.

In the simulation, modeling was carried out such that PMMA was used as a transparent resin material for the light guide sheet and the scattering particles were made of silicone.

In the Example, the light guide sheet 30 corresponding to a screen size of 40 inches was used. Specifically, the light guide sheet in which the length from the first light incidence surface 30c to the second light incidence surface 30d was set to 500 mm, the thickness of the light guide sheet 30 was set to 1.5 mm, the thickness of the second layer 62 at the bisector α, that is, the thickness of the second layer 62 at the position of the second local maximum value, was set to 0.61 mm, the thickness of the second layer 62 at the position of the first local maximum value was set to 0.21 mm, the thickness of the second layer 62 at the position at which the thickness of the second layer 62 is the smallest between the positions of the first local maximum value and the second local maximum value was set to 0.15 mm, and the distance from the position of the first local maximum value to the light incidence surface was set to 59 mm was used. The particle diameter of scattering particles mixed and dispersed in the light guide sheet was set to 4.5 μm, the particle concentration Npo of the first layer 60 was set to 0.02 wt % and the particle concentration Npr of the second layer 62 was set to 0.275 wt %.

A micro-lens film, which was formed of PMMA and in which micro-ball lenses with a diameter D_{L} of 120 μm and a height H_{L} of 20 μm were arranged on a film in a closest-packing manner, was used as the micro-lens films 32a and 32c.

A prism sheet with a prism pitch of 50 μm and a thickness of 200 μm was used as the prism sheet 32b.

In the backlight unit of the Example, the luminance distribution and the angular distribution of outgoing light were calculated. Regarding the angular distribution of outgoing light, the intensity corresponding to the angle of outgoing light emitted from a circular region with a diameter of 1 mm at the center of the exit surface of the backlight unit was calculated in the direction perpendicular to the light incidence surface 30c of the light guide sheet 30 (vertical direction) and in the direction parallel to the length direction of the light incidence surface (horizontal direction).

As a comparative example, the luminance distribution and the angular distribution of outgoing light were calculated using the same backlight unit as in the Example, except that a diffusing film was used instead of the micro-lens films 32a and 32c. Here, a diffusing sheet with total light transmittance of about 90%, a haze value of about 90%, and a thickness of 221 μm was used.

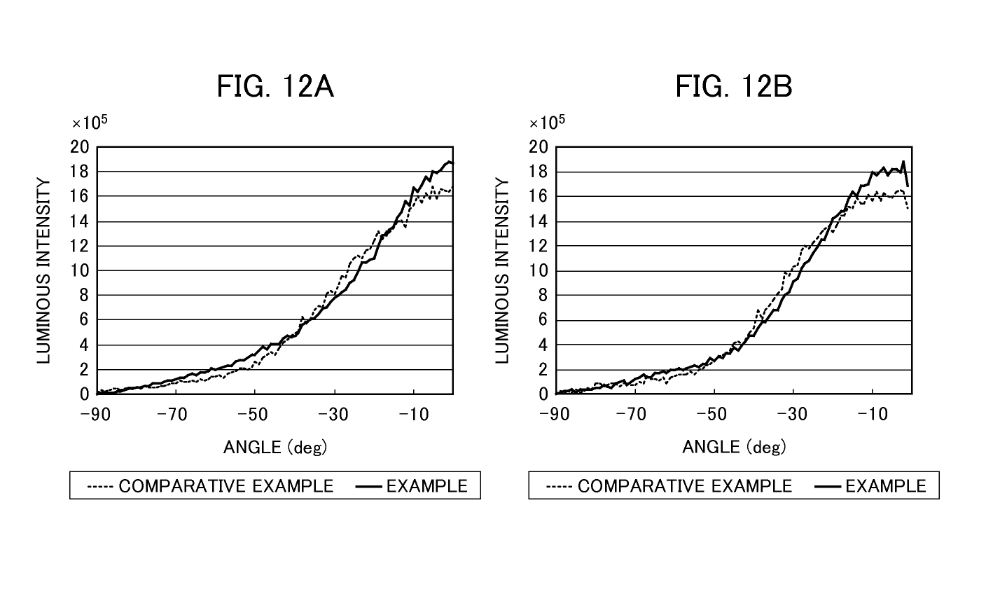

The measured luminance distributions are shown in FIG. 11 and the measured angular distributions are shown in FIG. 12A (vertical direction) and FIG. 12B (horizontal direction). In FIG. 11, the vertical axis represents the relative luminance (intensity of light) and the horizontal axis represents the position distant from the bisector α in the direction perpendicular to the light incidence surface [mm]. In FIGS. 12A and 12B, the vertical axis represents the luminous intensity [cd] and the horizontal axis represents the angle [deg] from the direction perpendicular to the light exit surface. In FIGS. 11, 12A and 12B, the Example is indicated by a solid line and the Comparative Example is indicated by a dotted line.

As shown in FIG. 11, it can be seen that the backlight unit 20 of the Example having the optical member unit including the micro-ball lens films was improved in luminance as a whole and was improved in light use efficiency, compared with the backlight unit of the Comparative Example having no micro-lens films. As shown in FIGS. 12A and 12B, it can be seen that the backlight unit of the Example was improved in intensity of light in the vicinity of 0° and was improved in front luminance, compared with the backlight unit of the Comparative Example. In this way, by configuring the optical member unit to have the micro-ball lens films, light emitted in various directions from the light exit surface 30a can be concentrated in the direction perpendicular to the light exit surface 30a and it is thus possible to improve the front luminance of illumination light emitted from the backlight unit, thereby improving light use efficiency.

While the planar lighting device according to the present invention has been described in detail, the present invention is not limited to the above-mentioned embodiments but may be improved or modified in various forms without departing from the gist of the present invention.

What is claimed is:

1. A planar lighting device comprising:
a light guide sheet that has a rectangular light exit surface, one or more light incidence surfaces, the one light incidence surface being disposed on a side of an edge of the light exit surface and allowing light traveling in a direction parallel to the light exit surface to enter into the light guide sheet, a rear surface opposite with the light exit surface, and scattering particles dispersed in the light guide sheet and that is not more than 2 mm thick in a direction perpendicular to the light exit surface;
one or more light source units, the one light source unit being so disposed as to face the one light incidence surface of the light guide sheet; and
an optical member unit including a micro-lens film with a plurality of spherical micro-ball lenses formed on a film that is so disposed as to face the light exit surface.

2. The planar lighting device according to claim 1,
wherein the light guide sheet includes two or more layers stacked in the direction perpendicular to the light exit surface and having the scattering particles dispersed therein at different particle concentrations.

3. The planar lighting device according to claim 2,
wherein the two or more layers of the light guide sheet respectively vary in thickness in the direction perpendicular to the light exit surface so that a combined particle concentration of the light guide sheet may have a first local maximum value on a side of the one light incidence surface and a second local maximum value larger and more distant from the one light incidence surface than the first local maximum value in a direction perpendicular to the one light incidence surface.

4. The planar lighting device according to claim 3,
wherein the light guide sheet includes a first layer on a side of the light exit surface and a second layer on a side of the rear surface, with the second layer having the scattering particles dispersed therein at a higher particle concentration than in the first layer, and
wherein the second layer continuously varies in thickness so that the thickness may increase, then decrease before increase again as a distance from the one light incidence surface is increased in the direction perpendicular to the one light incidence surface.

5. The planar lighting device according to claim 4,
wherein the light guide sheet has two light incidence surfaces disposed on sides of two edges of the light exit surface opposed to each other, and
wherein the second layer continuously varies in thickness so that the thickness may increase, then decrease before increase again as distances from the two light incidence surfaces are increased in a direction perpendicular to the two light incidence surfaces, and be maximum in a middle of the light exit surface.

6. The planar lighting device according to claim 4,
wherein the light guide sheet has a single light incidence surface disposed on a side of one edge of the light exit surface, and
wherein the second layer continuously varies in thickness so that the thickness may increase, then decrease before increase again as a distance from the single light incidence surface is increased in a direction perpendicular to the single light incidence surface, and be maximum on a side of a surface opposite with the light incidence surface.

7. The planar lighting device according to claim 4,
wherein when the particle concentration of the first layer of the light guide sheet is represented by Npo and the particle concentration of the second layer is represented by Npr, the Npo and the Npr fall in ranges of Npo=0 wt % and 0.01 wt %<Npr<0.8 wt %, respectively.

8. The planar lighting device according to claim 4,
wherein when the particle concentration of the first layer of the light guide sheet is represented by Npo and the particle concentration of the second layer is represented by Npr, the Npo and the Npr satisfy relations expressed as 0 wt %<Npo<0.15 wt % and Npo<Npr<0.8 wt %.

9. The planar lighting device according to claim 1,
wherein the rear surface of the light guide sheet is a flat surface parallel to the light exit surface.

10. The planar lighting device according to claim 1,
wherein the micro-ball lenses of the micro-lens film have a diameter ranging from 10 μm to 100 μm.

11. The planar lighting device according to claim 1,
wherein when a diameter of the micro-ball lenses of the micro-lens film is represented by D_{L} and a height of the micro-ball lenses is represented by H_{L}, the diameter D_{L} and the height H_{L} satisfy a relation expressed as D_{L}/2≧H_{L}≧D_{L}/8.

12. The planar lighting device according to claim 4,
wherein the micro-ball lenses of the micro-lens film have a diameter ranging from 10 μm to 100 μm, and
wherein when the diameter of the micro-ball lenses is represented by D_{L} and a height of the micro-ball lenses is represented by H_{L}, the diameter D_{L} and the height H_{L} satisfy a relation expressed as D_{L}/2≧H_{L}≧D_{L}/8.

13. The planar lighting device according to claim 1,
wherein the micro-ball lenses of the micro-lens film are randomly arranged on the film.

14. The planar lighting device according to claim 1,
wherein the micro-ball lenses of the micro-lens film have surfaces with a root-mean-square gradient ranging from 0.1 to 7.5.

15. The planar lighting device according to claim 12,
wherein the micro-ball lenses of the micro-lens film have surfaces with a root-mean-square gradient ranging from 0.1 to 7.5.

16. The planar lighting device according to claim 15,
wherein the micro-ball lenses of the micro-lens film are randomly arranged on the film.

17. The planar lighting device according to claim 1,
wherein the light guide sheet has a length of not less than 300 mm in a direction perpendicular to the one light incidence surface.
